(19) United States
(12) Patent Application Publication
(10) Pub. No.: US 2014/0059496 A1
(43) Pub. Date: Feb. 27, 2014

(54) UNIFIED MOBILE APPROVALS APPLICATION INCLUDING CARD DISPLAY

(71) Applicants: Brent-Kaan William White, San Francisco, CA (US); Kishan Agrawal, Fremont, CA (US)

(72) Inventors: Brent-Kaan William White, San Francisco, CA (US); Kishan Agrawal, Fremont, CA (US)

(73) Assignee: Oracle International Corporation, Redwood Shores, CA (US)

(21) Appl. No.: 13/593,416

(22) Filed: Aug. 23, 2012

(51) Int. Cl. G06F 3/048

(52) U.S. Cl. 715/841

(57) ABSTRACT

A system and method for facilitating use of electronic cards to represent and access computing objects via a mobile device. The example method includes graphically representing a first computing object via one or more electronic cards positioned in a first stack of electronic cards; providing a first user option to spread the stack of electronic cards, yielding spread cards; providing a second user option to select an electronic card from among the spread cards to trigger display of detailed data associated with the card; and providing a third user option to approve or reject an approval item associated with the card in response to user selection of the second user option. In a more specific embodiment, various card stack attributes, such as quantity of cards, type, and so on, may be illustrated graphically, such as via variations in stack depth, color coding, and so on.

### BACKGROUND

The present application relates to software and more specifically to user interface designs and accompanying methods for facilitating navigating and interacting with database objects or other computing objects.

Software for facilitating interacting with database objects is employed in various demanding applications, including mobile Enterprise Resource Planning (ERP) applications for managing human resources, accounts receivable, accounts payable, business projects, Customer Relationship Management (CRM), supply chain funding, Human Capital Management (HCM), Project Planning Management (PPM), finance, accounting, manufacturing and other business software that can be used to operate, monitor and/or manage a business. Such applications often demand efficient and intuitive user interface display mechanisms and accompanying data navigation and organization techniques than enable rapid access to and manipulation of relevant information.

Efficient mechanisms for accessing database objects are particularly important in enterprise approval applications, where delays in issuance of approvals or rejections for particular items or tasks can reduce business productivity.

In an example enterprise environment, managers may be tasked with issuing approvals or rejections, such as for job offers, invoice payments, expense reports, employee time cards, and so on. Conventionally, the approval process involves managers reviewing paper documents or cards and then physically signing or stamping the documents as approved or rejected. The documents are then physically delivered to an appropriate person or location. While use of paper documents is often simple and readily understood by managers, signing and/or stamping and delivering paper documents can be relatively cumbersome, inefficient, and time consuming.

Accordingly, software for facilitating issuing approvals is sometimes employed. However, existing approval software applications often employ complex menu systems, requiring that managers navigate through a series of menus to access data pertaining to a particular approval. Such menus often have relatively small menu items that are unwieldy when used with mobile devices.

Furthermore, existing approvals applications and accompanying menu systems often lack sufficient information needed to maintain context while navigating the menus. This can be particularly problematic in mobile implementations, where users are prone to distraction.

### SUMMARY

An example method facilitates use of electronic card-based data navigation and interaction via mobile devices deployed in enterprise computing environments. The example method facilitates employing electronic cards to represent and access computing objects, such as an enterprise database objects, also called business objects. The example method includes graphically representing a first computing object or portion thereof via one or more electronic cards positioned in a first stack (also called a pile) of electronic cards; providing a first user option to spread the stack of electronic cards, resulting in display of spread cards in response thereto; providing a second user option to select an electronic card from among the spread cards to trigger display of additional data not appearing on the face of the card; and providing a third user option to approve or reject an approval item associated with the card in response to user selection of the second user option.

In a more specific embodiment, plural stacks of electronic cards may be represented via a touch screen of a mobile device, and touch gestures may be employed to implement various user options. For example, in the specific embodiment, the first user option is implemented via a touch gesture, such as a two-finger swiping motion, applied to a touch screen of a mobile device. The second user option, which may be implemented via a tap gesture, may trigger display of animation representing a paper with data sliding beneath an electronic card that has been selected via the second user option.

Each stack of electronic cards corresponds to a particular type of electronic card, wherein each type of electronic card corresponds to a type of computing object. The example method includes specifying the type of electronic card (e.g., job offer, time card, expense report, and so on) via a color-coded or otherwise visually coded label on each card. Administrator options for enabling an administrator to define or change approval types associated with different stacks of cards may also be provided.

In the specific embodiment, each stack of electronic cards includes a top card, which illustrates, on a face of the top card, preselected information pertaining to the card. Example preselected information includes a name of a person and approval item type associated with the top card and a quantity. For the purposes of the present discussion, a quantity associated with a card may include any amount, measurement, or other metric associated with the card (or underlying computing object), such as a dollar amount for an invoice, a time for a time card, a salary for a job offer, and so on.

The computing object includes a database object of an Enterprise Resource Planning (ERP) system. The example specific method further includes employing the mobile device as a client to access one or more computing objects from one or more ERP applications that are in communication with an ERP server of the ERP system.

Each stack of electronic cards is characterized by a visually distinguishable stack depth, which indicates an approximate number of electronic cards in each stack. A predetermined set of stack depths may be mapped to card number ranges, such that different stack depths represent different ranges of numbers of cards in different card stacks.

An illustrative embodiment includes providing a fourth user option to simultaneously approve or reject approval items associated with plural spread cards. A stamp animation illustrates approval or rejection of one or more approval items.

Cards in a particular stack are sorted in accordance with a sorting rule, such as in accordance with a predetermined priority. The sorting rule may be user configurable or selectable and may include sorting based on age of each card, such that older cards are considered higher priority.

Hence, certain embodiments discussed herein may employ intuitive real world metaphors, where real world paper cards, approval stamping actions, and approval document arrangement are modeled via a graphical user interface that employs electronic cards, approval stamping animations, and card-based data navigations to yield a user friendly intuitive interface for facilitating implementing approvals. Intuitive interface features, such as employing card stack depth to indicate a number of approvals in a particular category; employing information on card faces to maintain context during data navigations; sorting cards such that a highest priority card appears on top of a card stack; and so on, enable users to quickly learn to efficiently use the software with little or no training. Use of such interfaces on mobile devices in enterprise environments may enhance business productivity by enabling users, such as managers, to rapidly register important informed approval decisions while out of the office.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating an example enterprise computing environment and accompanying system for facilitating electronic card-based data navigation for implementing approval functionality via a mobile device.

FIG. 2 is a diagram illustrating a first example user interface display screen with approval items represented by cards arranged in visually-coded stacks according to approval type.

FIG. 3 is a diagram illustrating a second example user interface display screen illustrating a spread stack, which may be displayed in response to a tap gesture applied to a stack shown in the touch screen of FIG. 2.

FIG. 4 is a diagram illustrating a third example user interface display screen illustrating additional card details, which may be displayed in response to a tap gesture applied to an electronic card of FIG. 3.

FIG. 5 is a diagram illustrating a fourth example user interface display screen illustrating example details associated with a first time card and illustrating an approval stamp being applied in response to user selection of an approval button.

FIG. 6 is a fifth example user interface display screen illustrating example details associated with a second time card and illustrating a rejection stamp being applied in response to user selection of a reject button.

FIG. 7 is a sixth example user interface display screen illustrating an alternative representation of stacked electronic cards.

FIG. 8 is a seventh example user interface display screen illustrating spread electronic cards in response to a two-finger gesture applied to the touch screen of FIG. 7.

FIG. 9 is an eighth example user interface display screen, which may be accessed by applying a tap-and-hold gesture to one of the user interface display screens of FIG. 7 or 8, and which enables a user to simultaneously approve or reject plural approval items, which are represented via spread cards.

FIG. 10 is diagram illustrating various example electronic card stack heights, which are assigned to different ranges of numbers of electronic cards appearing in each stack.

FIG. 11 is a flow diagram of an example method adapted for use with the embodiments of FIGS. 1-10.

### DETAILED DESCRIPTION OF EMBODIMENTS

Although the description has been described with respect to particular embodiments thereof, these particular embodiments are merely illustrative, and not restrictive.

For the purposes of the present discussion, enterprise data may be any information pertaining to an organization or business, including information about projects, tasks, resources, orders, and so on. Examples of enterprise data include descriptions of work orders, asset descriptions, photographs, and so on.

A mobile computing device, also called mobile device, may be any computer that is adapted for portable use. A computer may be any processor coupled to memory. Examples of mobile computing devices include laptops, notebook computers, smartphones and tablets (e.g., iPhone, iPad, Galaxy Tab, Windows Mobile, Windows 7, Android, and Blackberry smartphones and tablets, and so on), and so on. Various specific example embodiments discussed herein employ a mobile computing device further equipped with a network connection adapted to access enterprise computing resources on one or more servers.

An enterprise may be any organization of persons, such as a business, university, government, military, and so on. The terms “organization” and “enterprise” are employed interchangeably herein. Personnel of an organization, i.e., enterprise personnel, may include any persons associated with the organization, such as employees, contractors, board members, and so on.

An enterprise computing environment may be any computing environment used for an enterprise. A computing environment may be any collection of computing resources used to perform one or more tasks involving computer processing. An example enterprise computing environment includes various computing resources distributed across a network and may further include private and shared content on Intranet Web servers, databases, files on local hard discs or file servers, email systems, document management systems, portals, and so on.

ERP software may be any set of computer code that is adapted to facilitate managing resources, projects, and/or tasks of an organization. Example resources include Human Resources (HR), financial resources, assets, employees, and so on, of an enterprise. The terms “ERP software” and “ERP application” may be employed interchangeably herein. However, an ERP application may include one or more ERP software modules or components, such as user interface software modules or components. An ERP system may be any infrastructure, i.e., resources, such as hardware and ERP software, used to facilitate managing resources of an organization.

Enterprise software applications, such as Customer Relationship Management (CRM), Business Intelligence (BI), Enterprise Resource Planning (ERP), asset management, maintenance management, real estate management, and project management software, often include databases with various database objects, also called data objects or entities. A database object, also called a computing object herein, may be any collection of data and/or functionality, such as data pertaining to a particular financial account, asset, employee, contact, and so on. Examples of computing objects include, but are not limited to, records, tables, or other database entities corresponding to accounts receivables, products, employees, customers, business resources, and so on. Examples of functionality that may be included in a computing object include executable code; calls to programming language functions, procedures and/or scripts; hyperlinks, computer instructions for generating user interface controls, and so on.

For clarity, certain well-known components, such as hard drives, processors, operating systems, power supplies, and so on, have been omitted from the figures. However, those skilled in the art with access to the present teachings will know which components to implement and how to implement them to meet the needs of a given implementation.

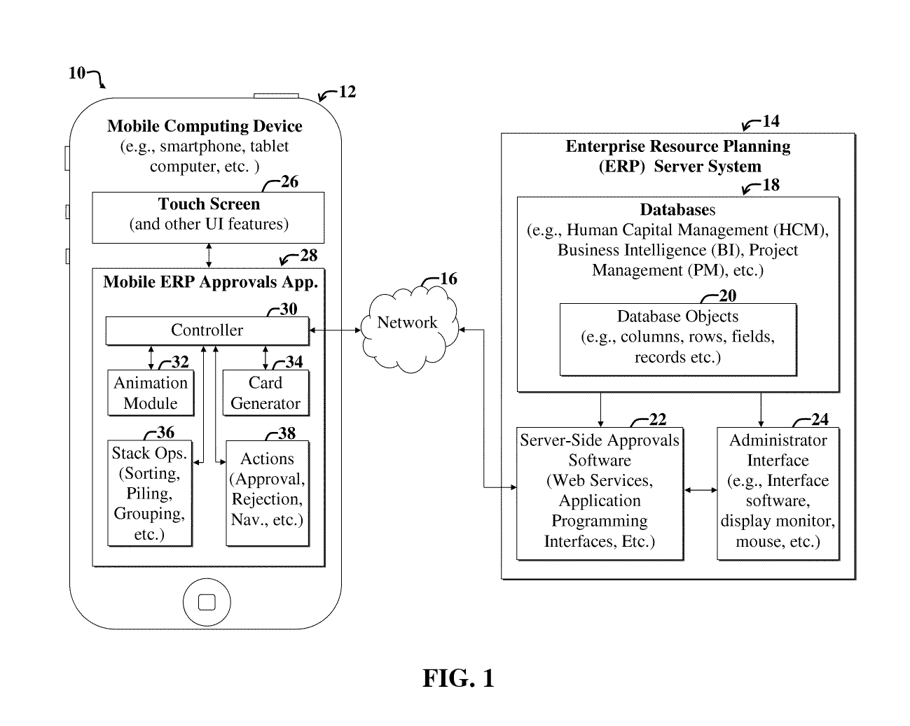

FIG. 1 is a diagram illustrating an example enterprise computing environment and accompanying system 10 for facilitating electronic card-based data navigation for implementing approval functionality via a mobile device 12. The example system 10 includes the mobile device 12 in communication with an ERP server system 14 via a network 16, such as the Internet. The mobile device 12 includes a touch screen 26, which facilitates user interaction with a mobile ERP approvals application 28. The ERP server system 14 hosts various ERP applications, including databases 18, which maintain various database objects 20, which are accessible to the mobile ERP approvals application of the mobile device 12 via the network 16 and server-side approvals software 22.

The terms “approvals software” or “approvals application” may be employed interchangeably to denote software that is adapted to facilitate registering approvals, i.e., acceptances or rejections of approval items (by persons using the approvals software), with one or more software applications, such as the databases 18. For the purposes of the present discussion, an approval item may be anything that may require a person's approval, rejection, or acknowledgement, such as a task, time card, expense report, and so on.

The ERP server system 14 further includes and administrator interface 24, which includes software for administering the server-side approvals software 22, including configuring templates for approval types and categories, specifying card stack sorting rules, interfacing the mobile ERP approvals application 28 with different ERP databases 18, and so on.

The administrator interface 24 may include hardware, such as a display monitor, keyboard, mouse, and so on, and software. Additional functionality for administrating and/or configuring the ERP databases 18 may also be included in the administrator interface 24 without departing from the scope of the present teachings.

The server-side approvals software 22 may include web services code, Application Programming Interface (API) code, and so on, to facilitate intercommunications between the ERP databases 18 with the mobile ERP approvals application 28. For example, in the present example embodiment, various database objects 20 and/or other data therefrom is sent to the mobile ERP approvals application via the server-side approvals software 22 and the network 16. The mobile ERP approvals application 28 then employs various components thereof to selectively graphically represent the database objects via electronic cards and/or data sheets associated with the electronic cards, as discussed more fully below.

For the purposes of the present discussion, an electronic card may be any collection of data and/or graphics presented in a region of a display screen. In the present example embodiment, the region of a card is marked by a substantially rectangular border, but other shapes, such as circles, may be possible. Electronic cards (also simply called cards herein) discussed herein may be stacked, sorted, spread, drilled into, approved, rejected, and so on. A card is said to be drilled into if the card is selected, such as via a tap gesture, to trigger display of additional data associated with the card and underlying database object.

A touch gesture may be any input provided to a touch-sensitive display by touching the display. A display may be touched with one or more fingers and/or other objects or devices, such as a stylus. A multi-touch gesture, such as a two-finger swipe, may be any gesture that involves contacting a touch-sensitive display simultaneously at different positions on the display. A gesture may include motion across a display or a tap at a predetermined position or any position of the display. Certain touch gestures may include touching the display and moving fingers or other devices in certain patterns across the display or across certain portions of the display to trigger different user interface input signals to control the user interface display screens and accompanying applications.

Example components of the mobile ERP approvals application 28 include a controller 30, which communicates with an animation module 32, an electronic card generator 34, a card stack operations module 36, and an actions module 38.

The controller 30 includes computer code for selectively calling software routines from the various modules 32-38 in response to user input from the touch screen 26 to facilitate card-based navigation of database objects and presentation of various user interface screens and accompanying functionality. The controller 30 may also include computer code for facilitating communicating with the databases 18 via the network 16 and server-side approvals software 22. Communications may include issuance of data requests by the mobile ERP approvals application 28 to the databases 18, and receipt of responses.

The animation module 32 includes computer code for implementing various animations. Example animations include a graphical depiction of an approval or rejection stamp being applied to a card when a user interface control, such as a button, is activated to approve or reject a card; a graphical depiction of a data sheet sliding beneath a card when a card is drilled into; and a graphical animation of cards being spread, when a particular gesture is applied to a stack of cards, as discussed more fully below.

The card generator 34 includes computer code for constructing cards based on underlying database objects. Card construction may include applying visually-coded labels to cards of a particular type; fetching data to be displayed on a card from a database object retrieved from the ERP server system 14, and so on.

The stack operations module 36 includes computer code for facilitating implementing various card stack functionality, such as sorting stacks according to a predetermined sorting rule; arranging stack positions according to another sorting rule; piling cards of a stack to a particular stack height based on a number of cards in a particular card type category; grouping cards in accordance with card type, i.e., category, and so on.

The actions module 38 includes computer code for facilitating implementing various actions, such as implementing an approval or a rejection of a particular card in response to corresponding user input; implementing card-based navigation between various user interface display screens presented via the touch screen 26, and so on, as discussed more fully below.

In an example operative scenario, a user, such as a manager, employs the mobile device 12 to run the mobile ERP approvals application 28. The mobile device 12 acts as a client device when communicating with the ERP server system 14. For the purposes of the present discussion, a client may be any computer, software, or system that is adapted to receive content from another computer or system, called a server.

Note that the mobile ERP approvals application 28 may be implemented such that communications with a server via a network are not required, without departing from the scope of the present teachings. For example, in certain implementations, the mobile device 12 may include client-side ERP databases sufficient to implement card-based navigation of approval items.

In the example operative scenario, the mobile ERP approvals application 28 retrieves database objects 20 from the ERP databases 18 and then constructs cards to be displayed on the touch screen 26 based on the retrieved objects. When an approval item is approved or rejected, a corresponding signal or message indicating that an approval item associated with a database object has been approved or rejected is then forwarded to the associated databases 18. The databases 18 may update the approval/rejection status of database objects accordingly.

Hence, the mobile ERP approvals application 28 represents a unified mobile application for approvals across applications, e.g., the databases 18, which maps database objects (such as ERP database objects, called business objects) to electronic approval request cards. The request cards are arranged in stacks, which include visual indications as to quantity. A top facing card of each stack may display sufficient information on its face to obviate the need (in certain implementations) to drill into underlying data associated with each card to obtain more data and to facilitate maintaining context during data navigation, as discussed more fully below.

While various modules of the system 10 are shown as separate modules, certain modules may be incorporated into other modules or may be separated from other modules, without departing from the scope of the present teachings. For example, in certain implementations the administrator interface 24 and associated functionality may be incorporated in the mobile ERP approvals application 28.

In general, the various modules of the system 10, such as the mobile ERP approvals application 28, server-side approvals software 22, and databases 18 may be implemented via one or more computer functions, procedures, routine libraries, and so on, and the functionality may be distributed among resources of a network or consolidated into a single software package. Similarly, the various modules of the system 10 may be implemented via a single computer or multiple computers distributed over a network, without departing from the scope of the present teachings.

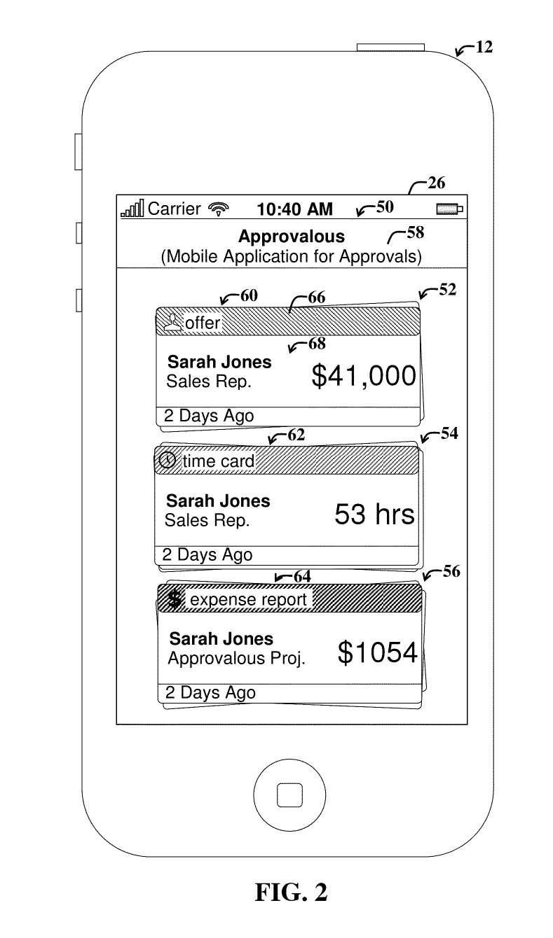

FIG. 2 is a diagram illustrating a first example user interface display screen 50 with approval items represented by cards arranged in visually-coded stacks 52-56 according to approval type. The stacks 52-56 have varying heights based on the number of approval items, i.e., cards, in each stack. Various of the stacks 52-56 are sorted according to a configurable sorting rule. The arrangement of or relative positioning of the stacks 52-56 may also be determined by a predetermined or configurable sorting rule.

For the purposes of the present discussion, a stack of electronic cards may be any graphical depiction of an electronic card that appears to be overlaid on top of one or more other electronic cards or that may otherwise be manipulated to reveal additional cards associated with the electronic card. The cards associated with the electronic card are said to be in the same stack or pile. The terms card stack or card pile may be employed interchangeably herein to refer to a stack of electronic cards.

In certain implementations, user configuration options, such as card sorting rules or stack arrangement sorting rules may be selected from a list or set of panels (not shown), which may be accessed via a particular touch gesture on a particular portion of the touch screen 26. For example, in an example implementation, tapping and holding a region of the touch screen 26 corresponding to a title bar 58 of the user interface display screen 50 may activate a drop-down menu, which may provide various user configuration options.

In the present example embodiment, the card stacks 52-56 include an offer stack 52, a time card stack 54, and an expense report stack 56. Each of the stacks 52-56 are visually coded, e.g., color coded, to facilitate distinguishing the stacks 52-56, which represent groupings based on approval item type. An approval item type corresponds to a type of underlying database object represented by a given card or cards of a given stack. Exact names for different types of approval items are implementation specific and may be configurable, e.g., by an administrator via the administrator interface 24 of FIG. 1.

The offer stack 52 includes various cards, including a top card 60. A face of the top card 60 includes a header 66, which is visually coded to distinguish the card by approval item type, and a body 68. For the purposes of the present discussion, a face of an electronic card may represent a portion of information that is visible on the card when the card is displayed in a user interface display screen.

The body 66 of the card 60 includes preselected information basic identification information, such as an applicable person's name, applicable job title, amount (e.g., dollar amount) associated with the corresponding approval item, and age of the approval item. The type of preselected information appearing on the face of the card 60 may be selected by an administrator via the administrator interface 24 of FIG. 1 before a user uses the mobile ERP approvals application 28. The age of the approval item may represent how long the approval item associated with the card 60 has been waiting for the user to accept or reject the approval item.

For the purposes of the present discussion, a quantity or amount associated with a card may include a dollar amount for an invoice, a time for a time card, a salary for a job offer, and so on.

A visually coded graphic, indicator, label, or header may be any user interface element whose appearance has been adjusted in accordance with a scheme. For example, the color of a graphic may be adjusted to represent different ranges of values. Note that coding other than color coding may be employed. For example, outlines, textures, and shapes and/or sizes of graphics may be adjusted in accordance with different types, values or ranges of values associated with a given user interface element.

In the present example embodiment, the top facing offer card 60 has been sorted to the top of the offer stack 52 based on a predetermined sorting rule. An example sorting rule calculates card priority based on an age of the card or based on an urgency or other flag or attribute, which may have been previously associated with the card.

Note that other sorting rules, such as alphabetical sorting, sorting based on amounts (e.g., dollar amount, time, and so on) associated with each approval item, and so on, may be applied to a card stack, without departing from the scope of the present teachings.

Similarly, the top facing time card 62 and expense report card 64 represent highest priority cards of their respective stacks, and the cards 62, 64 have visually coded headers and include bodies with preselected summary information, such as name, job title, and amount or quantity associated with the corresponding approval item representative of an underlying database object associated with each card.

Note that exact card size, shape, and general appearance are implementation specific and may vary depending upon the needs of a given implementation. In certain implementations computer code and associated functionality for configuring appearance of cards may be provided in the server-side administrator interface 24 of FIG. 1. Furthermore, note that additional or less information than that shown on the faces of the cards 60-62 may be added to or removed from the faces of the cards 60-62 without departing from the scope of the present teachings.

The various stacks 52-56 may exhibit various functionality depending upon the implementation. For example, in the present example embodiment, certain touch screen gestures may be employed to spread one or more of the stacks 52-56; to scroll the stacks 52-56 upward or downward to reveal any additional stacks; to change relative stack order or positioning, e.g., by selecting and applying an ordering or sorting rule, and so on.

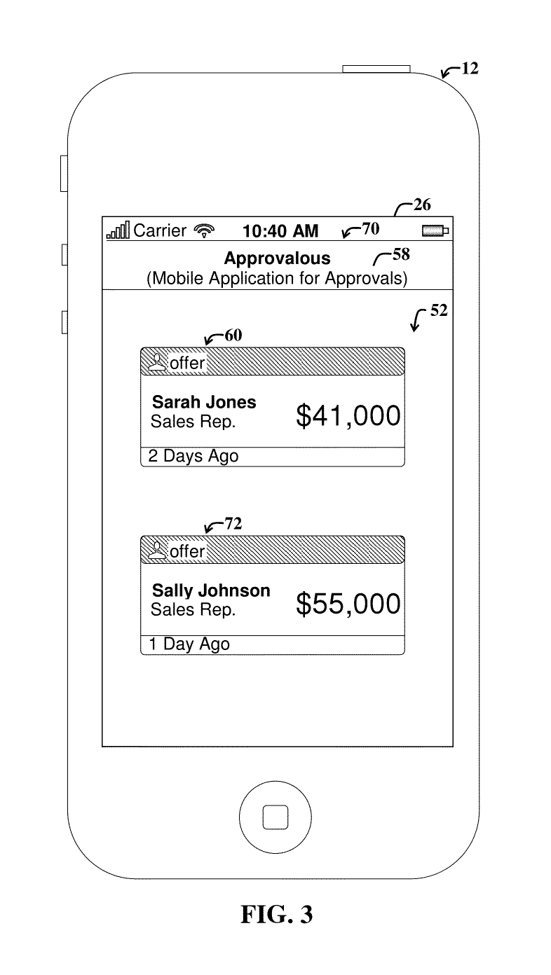

FIG. 3 is a diagram illustrating a second example user interface display screen 70 illustrating a spread offer stack 52, which may be displayed in response to a tap gesture applied to a stack shown in the touch screen 26 of FIG. 2.

Note that gestures other than a tap gesture may be employed to spread a card stack, without departing from the scope of the present teachings. For example, in certain implementations, a two-finger swiping motion applied across an entire touch screen may result in spreading of all card stacks displayed via the touch screen. The origin and endpoints for a two-finger swipe gesture may determine the gesture response. For example, a two-finger swipe gesture that passes over three card stacks may spread all three stacks, while a two-finger swipe gesture that originates and ends on one card stack may only spread the one card stack.

In the present example embodiment, the act of spreading of the cards 60, 72 of the offer stack 52 is graphically illustrated via an animation that illustrates the second offer card 72 sliding out from beneath the top offer card 60. Similar animations may be implemented to illustrate the spreading of other stacks, such as the time card stack 62 and expense report stack 64 of FIG. 2.

The offer stack 52 of FIG. 2 is shown spread in FIG. 3 to reveal another offer card 72 that was beneath the top offer card 60. For the purposes of the present discussion, a stack of electronic cards is said to be spread if plural cards represented by the stack of electronic cards are arranged so that faces of electronic cards represented by the stack become visible.

Note that use of a gesture to spread the stack 52 represents a type of card-based navigation, also called card-based data navigation. Navigation may refer to any process whereby a user interface display screen is updated to reveal different data and/or a different configuration of user interface elements in a display screen. Card-based navigation may refer to any navigation that employs electronic cards (e.g., as opposed to merely menus and associated buttons or links) to facilitate navigation.

Conventionally, data navigation in a software application is implemented via menus, hyperlinks, and other user interface controls. However, use of conventional menus and buttons for navigation, as opposed to card-based navigation discussed herein, may be cumbersome; particularly in mobile applications, where small menu items may be difficult to select, manipulate, and view.

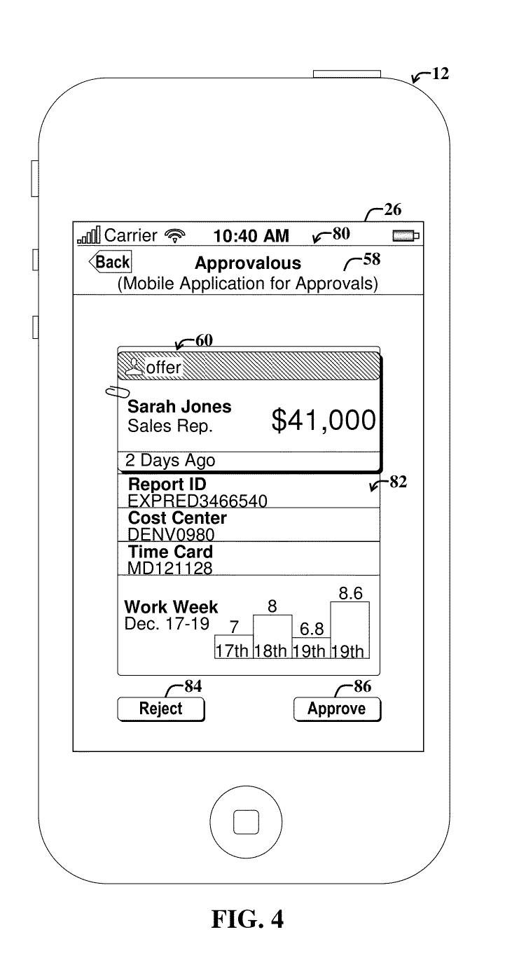

FIG. 4 is a diagram illustrating a third example user interface display screen 80 illustrating additional card details via a data sheet 82, which may be displayed in response to a tap gesture applied to the offer card 60 of FIG. 3. Additional data illustrated via the data sheet 82 may include graphics or visualizations, identifications numbers, and so on pertaining to the associated approval item.

In the present example embodiment, the user interface display screen 80 represents the last frame of animation that involves sliding the data sheet underneath the offer card 60, and applying a paper clip. Note that the display screen 80 includes a depiction of the card 60, which facilitates maintenance of context as a user navigates various user interface display screens.

The third example user interface display screen 80 further includes a reject button 84 and an approval button 86, which represent user options for rejecting and approving, respectively, the approval item represented via the offer card 60.

User selection of the reject button 84 or approve button 86 may trigger display of an animation of a corresponding rejection or approval stamp being applied to the offer card 60 and/or data sheet 82. After the associated approval item is approved or rejected, the offer card 60 and accompanying data sheet 82 with the applicable stamp may automatically disappear from the display screen 80, and the screen 80 may automatically return to displaying any remaining spread offer cards that have yet to be approved. Applicable ERP databases may be updated with an approval or rejection notice pertaining to the database object associated with the approval item.

In certain implementations, a user may return to a previous screen by applying a particular touch screen gesture or other input, such as shaking the phone 12 or tapping the screen title (“Approvalous”) in the title bar 58. Alternatively, a back button provided in the title bar 58 may be employed to return to a previous display screen.

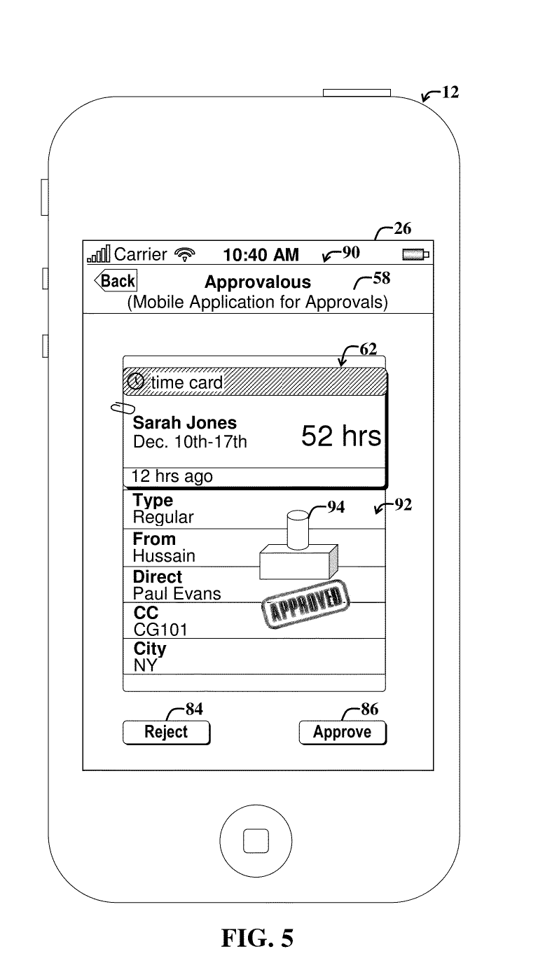

FIG. 5 is a diagram illustrating a fourth example user interface display screen 90 illustrating example details associated with the top time card 62 and illustrating an approval stamp 94 being applied to a time data sheet 92 in response to user selection of an approval button 86. The fourth example user interface display screen 90 for the time card 62 represents a details screen, which may be arrived at by spreading the stack 54 of FIG. 2, e.g., via a two-finger swipe, and then taping on the resulting display of the time card 62 appearing among resulting spread cards. Alternatively, or in addition, different predetermined touch screen gestures (other than those employed for other transitions discussed herein) may be employed to transition directly from one of the stacks 52-54 of FIG. 2 to a details screen with an accompanying data sheet (as opposed to transitioning first to a spread stack before transitioning to a details screen, such as the screen 90).

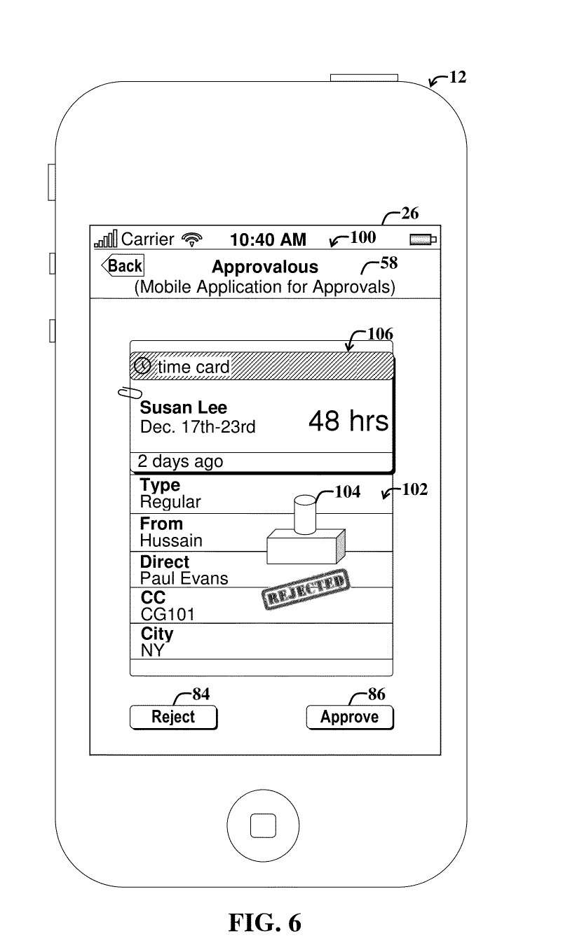

FIG. 6 is a fifth example user interface display screen 100 illustrating example details associated with a second time card 106 and illustrating a rejection stamp 104 being applied to a time card data sheet 102 in response to user selection of the reject button 84.

Note that stamp animations employed via the user interface display screens 90, 100 of FIGS. 5-6 may include sound, such as stamping sounds and/or paper shuffling sounds. User options for turning on or off animations or sounds may be provided via one or more menus (not shown) that may appear in the user interface display screens 90, 100 in response to one or more predetermine touch screen gestures.

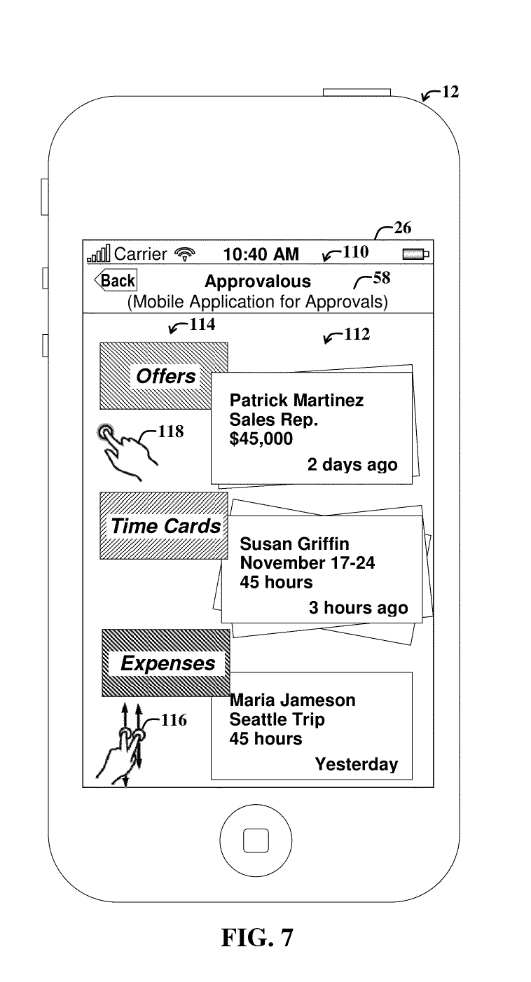

FIG. 7 is a sixth example user interface display screen 110 illustrating an alternative representation of stacked electronic cards 112. The sixth example user interface display screen 110 includes stacks 112, which are arranged in categories based on the types of cards in each stack, as indicated by visually coded side labels 114. The visually coded side labels 114 are offset to the upper left of each stack 112.

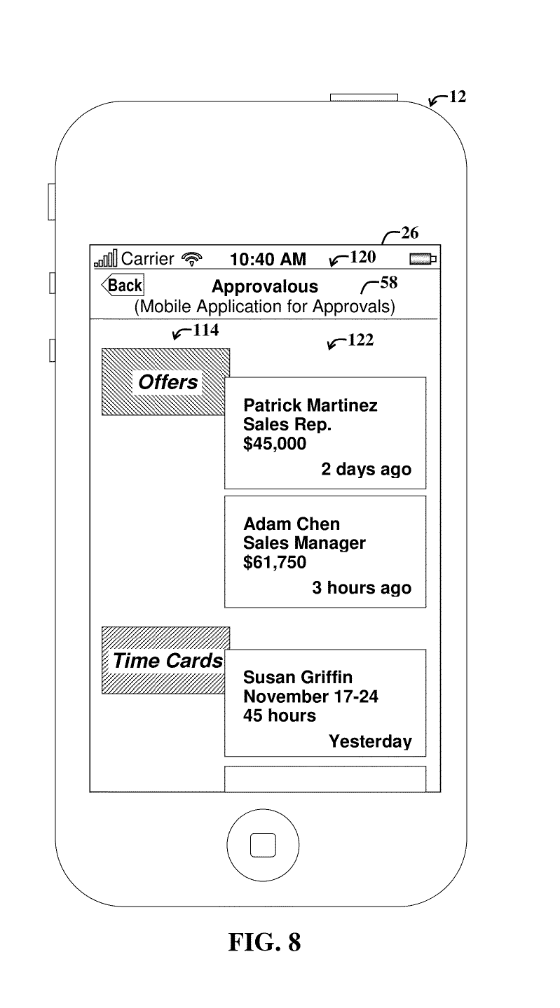

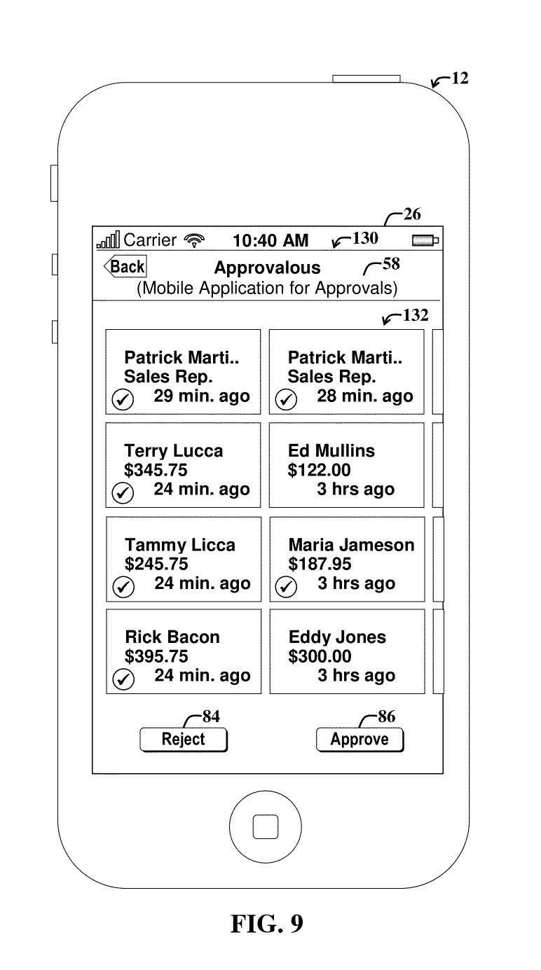

An example of a two-finger swipe gesture 116 and a tap-and-hold gesture 118 are illustrated in FIG. 7. The two-finger swipe gesture 116 applied in a downward motion may be employed to un-stack, i.e., spread all of the stacks 112, resulting in a seventh example user interface display screen 120 shown in FIG. 8. The tap-and-hold gesture 118 may be applied to the sixth example user interface display screen 110 of FIG. 7 or to the seventh example user interface display screen 120 of FIG. 8 to transition to an eighth example user interface display screen 130 shown in FIG. 9.

FIG. 8 is a seventh example user interface display screen 120 illustrating spread electronic cards 122 in response to the two-finger gesture 116 applied to the touch screen 26 of FIG. 7. In the present example embodiment, the spread cards 122 are automatically chronologically ordered within each category in response to the two-finger downward swipe 116 illustrated in FIG. 7. A two-finger upward swipe may be employed to restack the cards 122, thereby returning to sixth example user interface display screen 110 of FIG. 7.

Note that while the spread cards 122 are shown chronologically ordered within each category, other types of ordering may be employed. For example, spread cards may be chronologically ordered across categories, such that when multiple stacks are spread, the spread cards are ordered into a single chronologically ordered list of cards. Furthermore, the card stacks (not merely the cards therein), as identified by the visually coded side labels 114, may also be ordered by a desired scheme, such as manually, chronologically, alphabetically, by predetermined priority rating, and so on.

FIG. 9 is an eighth example user interface display screen 130, which may be accessed by applying a tap-and-hold gesture to one of the user interface display screens 110, 120 of FIG. 7 or 8, and which enables a user to simultaneously approve or reject plural approval items, which are represented via plural spread cards 132.

In the present specific embodiment, a user may selectively tap one or more of the spread cards 132 to toggle selection of one or more of the spread cards 132. Cards that have been selected for approval or rejection are indicated by check marks in the lower left corners. A user may then select the approve button 86 or reject button 84 to simultaneously approve or reject, respectively, multiple selected cards from among the spread cards 132.

Hence, the user interface design represented in FIGS. 2-9 is adapted to allow users to use shortcut gestures (e.g., via a two-finger swipe) to organize card stacks into a single chronologically ordered list (e.g., as shown via the list 122 of FIG. 8), to invoke a multiple card approval interface (e.g., the display screen 132 of FIG. 9); to un-spread listed, i.e., spread cards (e.g., via an upward two-finger swipe), and so on.

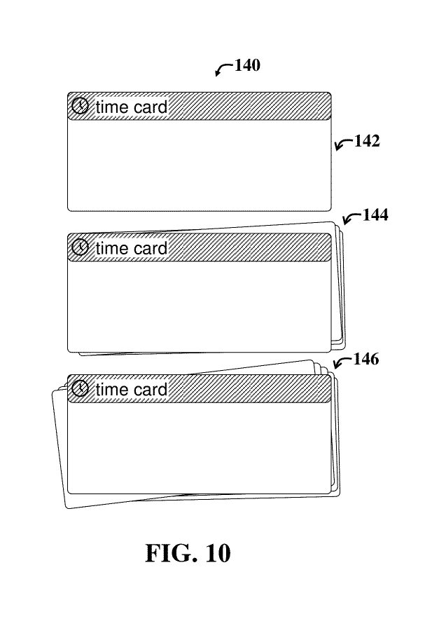

FIG. 10 is diagram illustrating various example electronic card stack heights 140, which are assigned to different ranges of numbers of electronic cards appearing in each stack. For example, a single-card stack 142 is shown as substantially flat. A first multiple card stack 144 with between two and eight cards may be approximated as a slightly skewed pile with edges of multiple cards showing. A second multiple card stack 146 may be employed to represent stacks with eight or more cards. The second multiple card stack 146 has more card edges appearing about a perimeter of the stack 146 than stacks 142, 144 representing fewer cards.

Hence, different stack heights may represent different ranges of numbers of electronic cards in a stack based on apparent stack depth associated with the range of numbers. Note that different associations or groupings between stack appearances and numbers of cards or ranges of numbers of cards appearing in the stack may vary depending upon the implementation and need not be limited to those shown in FIG. 10.

In summary, various embodiments discussed herein present an interface paradigm of approval request cards. Each approval card has its own visual treatment, and the initial view (e.g., as shown in FIG. 2) shows cards stacked into category piles. The depth of the pile communicates the number of pending approvals. Cards may also be used for other types of business objects such as purchase orders that are categorized by type or department.

Approval cards remain consistent throughout all three states of the design, thereby conserving context as a user navigates the user interface. The same approval card may appear atop a category, within a category list, and also in a detail screen, keeping the user in context.

Custom animations are used to transition from the card pile to individual cards within a category and from an individual card to a detailed view. Furthermore, users can immediately understand the type of category content, since certain key details of the card that is on top of the pile remain in view during navigation. The top card may also be the most important if the pile is sorted by highest relevancy to the end user.

Furthermore, certain embodiments discussed herein employ a flexible architecture that supports the dynamic creation of approval types and the customization of attributes via a cloud application. Software for implementing embodiments discussed herein may represent a generic approval engine that can be integrated with any application, standard or custom. Application Programming Interfaces (APIs) and web services may be employed to facilitate integrations. Applications may send or otherwise transfer approval objects via the web services and/or APIs.

The approval engine may determine approvers/levels based on the approval object's attributes. Approvers may see all pending approvals in a particular approval application. Once approved/rejected, the approval application sends the response back to originating applications. Multiple applications can be integrated within the approval application and accompanying engine, and each integrated application can define its own approval rules. Users need only go to only one application for all their approval actions.

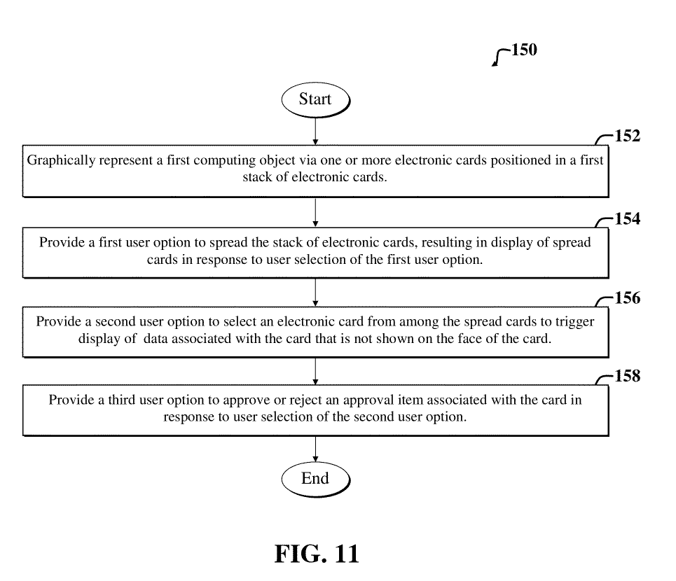

FIG. 11 is a flow diagram of an example method 150 adapted for use with the embodiments of FIGS. 1-10. The example method 150 facilitates representing and accessing a computing object via a mobile device. The method 150 includes a first step 152, which involves graphically representing a first computing object, such as a computing object corresponding to a time card, job offer, expense report, invoice, purchase order, and so on, via one or more electronic cards positioned in a first stack of electronic cards.

A second step 154 includes providing a first user option to spread the stack of electronic cards, resulting in display of spread cards in response to user selection of the first user option.

A third step 156 includes providing a second user option to select an electronic card from among the spread cards to trigger display of data associated with the card that is not shown on the face of the card.

A fourth step 158 includes providing a third user option to approve or reject an approval item associated with the card in response to user selection of the second user option.

While the present application has been discussed with respect to use of card based navigation to facilitate approvals pertaining to database objects used in ERP applications, embodiments are not limited thereto. For example, user interface implementations for browsing, navigating, and/or interacting with computing objects unrelated to ERP approvals may be constructed using card-based navigation as discussed herein without departing from the scope of the present teachings. For example, various types of computing objects, other than ERP database objects, may be represented via stacked identifying cards that can be spread and selectively displayed along with data sheets and accompanying user interface controls for implementing desired actions associated with the computing objects.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method executing on a mobile device, the method comprising:
graphically representing a first computing object via one or more electronic cards positioned in a first stack of electronic cards;
providing a first user option to spread the stack of electronic cards, resulting in display of spread cards in response to user selection of the first user option;
providing a second user option to select an electronic card from among the spread cards to trigger display of data associated with the card that is not shown on the face of the card; and
providing a third user option to approve or reject an approval item associated with the card in response to user selection of the second user option.

2. The method of claim 1, further including providing plural stacks of electronic cards, including the first stack of electronic cards, wherein each stack of electronic cards corresponds to a particular type of electronic card, wherein a type of electronic card corresponds to a type of the first computing object.

3. The method of claim 2, wherein the type of electronic card is indicated by a visually coded label on each card.

4. The method of claim 3, wherein the label includes a name of the card type.

5. The method of claim 4, wherein the card type includes job offer, time card, or expense report.

6. The method of claim 2, wherein stack of the plural stacks of electronic cards includes a top card, which illustrates, on a face of the top card, preselected information pertaining to the card, wherein the preselected information includes a name of the card and a quantity associated with the card.

7. The method of claim 2, wherein the computing object includes a database object used in business software.

8. The method of claim 7, further including employing the mobile device as a client to access one or more computing objects from one or more ERP applications that are in communication with an ERP server of the ERP system.

9. The method of claim 2, further including depicting each stack as having a stack depth, wherein the stack depth indicates a number of electronic cards in each stack of the plural stacks.

10. The method of claim 9, further including representing a range of numbers of electronic cards in a stack by a stack depth associated with the range of numbers.

11. The method of claim 2, wherein the first user option to spread the stack of cards includes a user option to employ a first touch gesture on a touch screen.

12. The method of claim 11, wherein the first touch gesture includes a two-finger swiping motion applied to the touch screen.

13. The method of claim 2, further including providing a third user option to employ a second touch gesture applied to a touch screen to trigger display of plural spread cards of the plural stacks of electronic cards.

14. The method of claim 13, wherein a display of plural spread cards includes a user option to simultaneously approve or reject approval items associated with each of the plural spread cards.

15. The method of claim 2, further including providing a stamp animation that illustrates a portion of an electronic card being stamped as approved or rejected in response to user approval or rejection of an approval item.

16. The method of claim 15, wherein user selection of the second user option is adapted to trigger an animation representing a paper with the data sliding beneath the electronic card that is selected via the second user option.

17. The method of claim 1, further including arranging electronic cards in a stack of electronic cards based on a priority of one or more of the electronic cards.

18. The method of claim 17, further including determining a priority of a card based on an age of the card.

19. An apparatus comprising:
a digital processor coupled to a display and to a processor-readable storage device, wherein the processor-readable storage device includes one or more instructions executable by the digital processor to perform the following acts:
graphically representing a first computing object via one or more electronic cards positioned in a first stack of electronic cards;
providing a first user option, via a display screen of a mobile device, to spread the stack of electronic cards, resulting in display of spread cards in response to user selection of the first user option;
providing a second user option to select an electronic card from among the spread cards to trigger display of data associated with the card that is not shown on the face of the card; and
providing a third user option to approve or reject an approval item associated with the card in response to user selection of the second user option.

20. A processor-readable storage device including instructions executable by a digital processor, the processor-readable storage device including one or more instructions for:
graphically representing a first computing object via one or more electronic cards positioned in a first stack of electronic cards;
providing a first user option, via a display screen of a mobile device, to spread the stack of electronic cards, resulting in display of spread cards in response to user selection of the first user option;
providing a second user option to select an electronic card from among the spread cards to trigger display of data associated with the card that is not shown on the face of the card; and
providing a third user option to approve or reject an approval item associated with the card in response to user selection of the second user option.
